(19) United States
(12) Patent Application Publication
(10) Pub. No.: US 2010/0300774 A1
(43) Pub. Date: Dec. 2, 2010

(54) Digital Pen

(76) Inventors: Chih-Lin Yang, Tu-Cheng City (TW); Hsin-Tsung Ho, Tu-Cheng City (TW)

Correspondence Address: LIN & ASSOCIATES INTELLECTUAL PROPERTY, INC., P.O. BOX 2339, SARATOGA, CA, 95070-0339, US

(21) Appl. No.: 12/471,569

(22) Filed: May 26, 2009

(51) Int. Cl. G06F 3/033

(52) U.S. Cl. 178/19.01

(57) ABSTRACT

A digital pen includes a tubular body defining an inserting hole and a connector received in the inserting hole. Two opposite side edges of the inserting hole protrude face-to-face to form a locating lump and a fixing board. The connector includes an insulating housing and a plurality of terminals integrated in the insulating housing. A rear edge of the insulating housing extends downward to form a connecting arm located behind a rear surface of the insulating housing with a space therebetween. A free end of the connecting arm protrudes opposite to the rear surface to form a buckling portion. A rear of the insulating housing extends rearward to form a projection beyond the rear surface. The fixing board of the tubular body is jammed between the buckling portion and the projection. A front of the insulating housing defines a locating gap for holding the locating lump of the tubular body therein.

### BACKGROUND OF THE INVENTION

1. Field of the Invention

The present invention generally relates to a digital pen, and more particularly to a digital pen with a connector.

2. The Related Art

With the advancement of digital technology a digital pen comes with the tide of fashion. The digital pen is an input device for inputting the handwritten information to a personal computer, a mobile phone or a personal digital assistant by means of Bluetooth or other transmission means.

A traditional digital pen includes a tubular body and a connector received in the tubular body. The digital pen is substantially of cylindrical shape so as to be conveniently carried and used. The tubular body has an inserting hole to receive the connector therein and an edge of the inserting hole protrudes outward to form a lump. The connector defines a locating gap for fixing the lump of the tubular body therein. However, the tubular body and the connector are engaged with each other only by means of the lump of the tubular body being fixed in the locating gap of the connector, so the connector is apt to fall off the tubular body under shaking. As a result, the signal transmission of the digital pen is not steady. Therefore, a digital pen capable of overcoming the foregoing problem is required.

### SUMMARY OF THE INVENTION

An object of the present invention is to provide a digital pen. The digital pen includes a tubular body defining an inserting hole at an outer peripheral surface thereof and a connector received in the inserting hole of the tubular body. Two opposite side edges of the inserting hole protrude face-to-face to form a locating lump and a fixing board spaced from each other. The connector includes an insulating housing having a base body and a plurality of terminals integrated in the insulating housing. The base body has a top surface and a rear surface. A rear edge of the top surface extends downward to form a connecting arm located behind the rear surface of the base body with a space therebetween. A free end of the connecting arm protrudes opposite to the rear surface to form a buckling portion. A rear of the top surface of the base body extends rearward to form a projection beyond the rear surface. The fixing board of the tubular body is jammed between the buckling portion and the projection from the buckling portion. A front of the insulating housing defines a locating gap for holding the locating lump of the tubular body therein.

As described above, the locating lump of the tubular body is held in the locating gap of the connector, and the fixing board is jammed between the buckling portion and the projection so that can prevent the connector from falling off the tubular body under shaking and further remain a steady signal transmission of the digital pen.

### BRIEF DESCRIPTION OF THE DRAWINGS

The present invention will be apparent to those skilled in the art by reading the following description, with reference to the attached drawings, in which:

FIG. 1 is a partial cross-sectional view of a digital pen according to the present invention;

FIG. 2 is an exploded view of the digital pen of the present invention;

FIG. 3 is an exploded view of a connector of the digital pen of FIG. 2;

FIG. 4 is a perspective view of an insulating housing of the connector of FIG. 3;

FIG. 5 is an enlarged view of an encircled portion A of the digital pen of FIG. 1;

FIG. 6 is a partial cross-sectional view showing that the connector is mated with a tubular body of the digital pen of FIG. 2; and

FIG. 7 is a cutaway perspective view showing that the connector is mated with the tubular body of the digital pen of FIG. 2.

### DETAILED DESCRIPTION OF THE PREFERRED EMBODIMENT

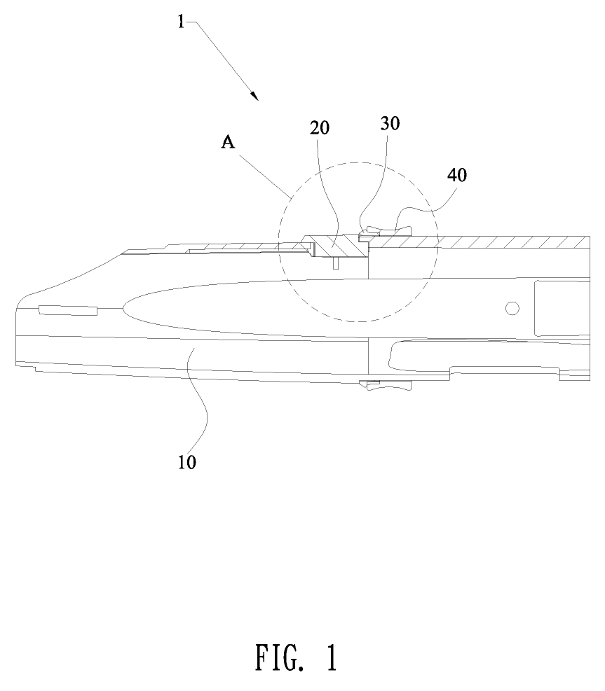

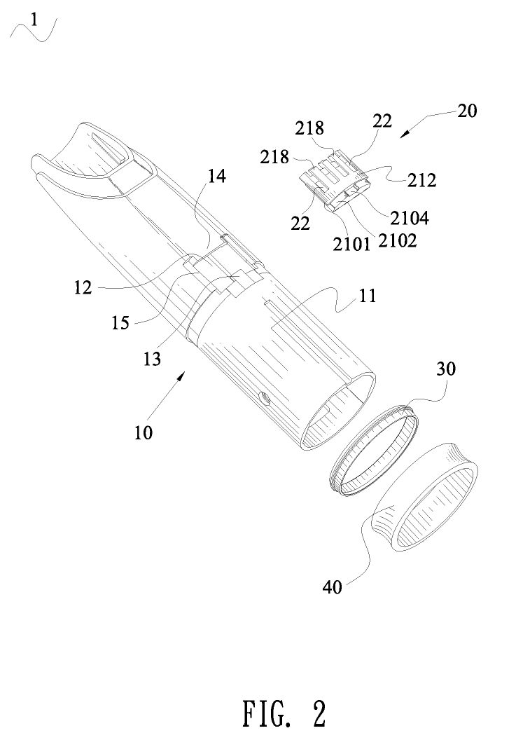

With reference to FIG. 1 and FIG. 2, a digital pen 1 according to the present invention is shown. The digital pen 1 includes a tubular body 10, a connector 20 mated with the tubular body 10, a first fixing ring 30 and a second fixing ring 40.

Referring to FIG. 2, the tubular body 10 is of substantially cylindrical shape. A middle of an outer peripheral surface 11 of the tubular body 10 defines a rectangular inserting hole 12 penetrating therethrough. Two opposite edges of the inserting hole 12 substantially perpendicular to the extending direction of the tubular body 10 protrude face-to-face to form a locating lump 13 and a fixing board 14 spaced from each other and located in the inserting hole 12. A pair of holding grooves 15 is provided on another two opposite side edges of the inserting hole 12 substantially parallel with the extending direction of the tubular body and extends along the respective side edges.

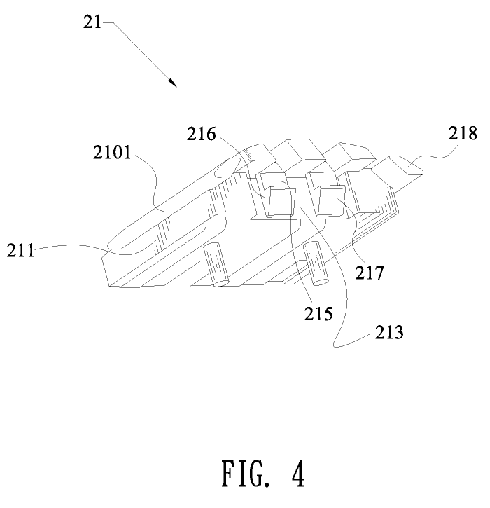

Referring to FIG. 2 to FIG. 4, the connector 20 corresponding to the inserting hole 12 of the tubular body 10 includes an insulating housing 21 and a plurality of terminals 22 integrated in the insulating housing 21. The insulating housing 21 has a base body 211 with an arc-shaped top surface 212 and a rear surface 213. A middle of the top surface 212 of the base body 211 defines a plurality of terminal passageways 214 arranged at regular intervals along a peripheral direction thereof and each extending longitudinally. A rear edge of the top surface 212 of the base body 211 extends downward to form a pair of connecting arms 215 spaced from each other and further located behind the rear surface 213 of the base body 211 with a space. A bottom end of each of the connecting arms 215 is protruded opposite to the rear surface 213 of the base body 211 to form a buckling portion 216 having an inverted right triangle section of which an inclined plane is acted as a guiding surface 217 opposite to the rear surface 213 of the base body 211. A rear of the top surface 212 of the base body 211 extends rearward to form a plurality of projections 218 beyond the rear surface 213 of the base body 211 and arranged at regular intervals along the peripheral direction thereof. A trough 219 is formed between two adjacent projections 218 and communicates with the corresponding terminal passageway 214. Two opposite side edges of the top surface 212 of the base body 211 extend oppositely to form a pair of fixing eaves 2101 each extending longitudinally. A front of the base body 211 is provided with a stepped portion 2102 with an arc-shaped top surface 2103 lower than that of the base body 211 and a middle of the top surface 2103 of the stepped portion 2102 defines a locating gap 2104.

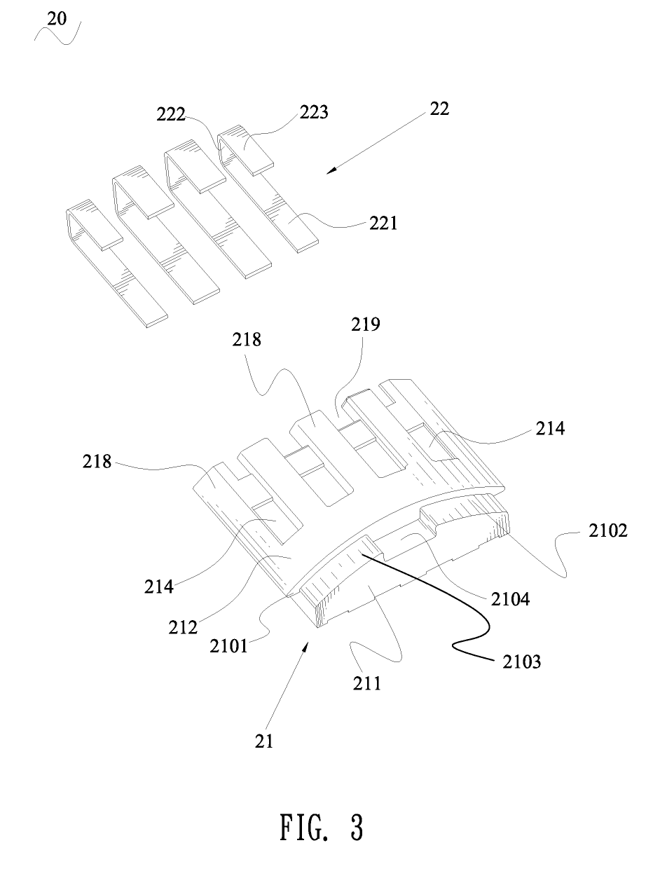

Referring to FIG. 2 and FIG. 3 again, each of the terminals 22 has a flat rectangular base board 221. One end of the base board 221 is bent upward to form a connecting board 222. The base board 221 and the connecting board 222 are molded in the insulating housing 21. A free end of the connecting board 222 is bent and extends towards the same side with the base board 221 to form a contact board 223 paralleling to the base board 221 and lain in the corresponding terminal passageway 214.

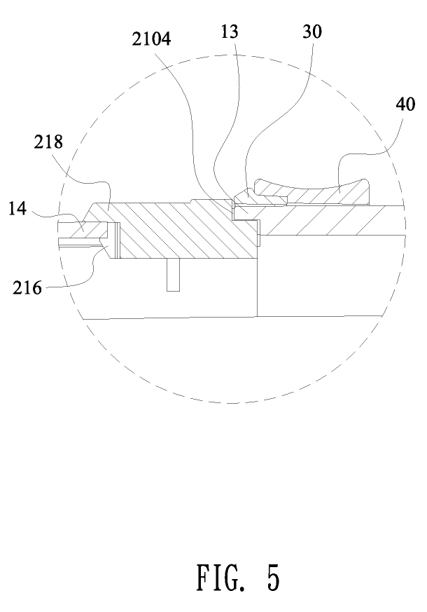

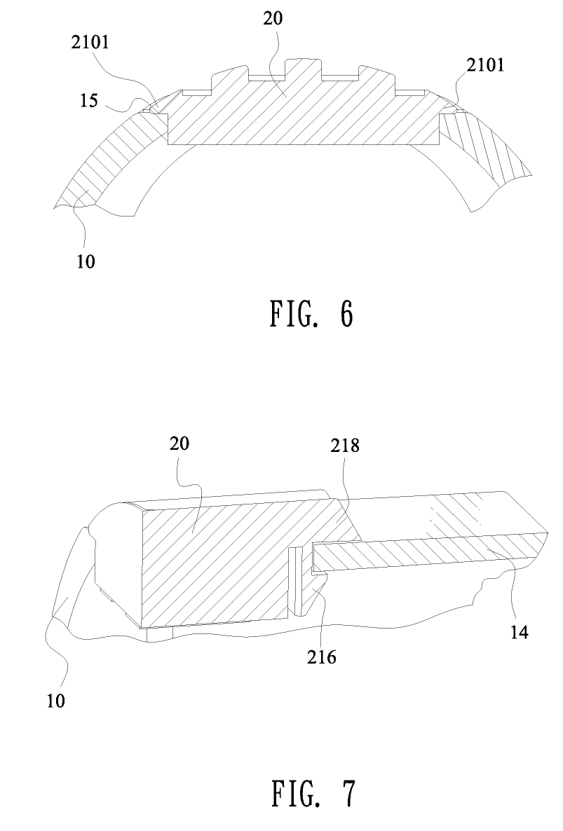

With reference to FIG. 5 to FIG. 7, in assembly, the connector 20 is mounted in the inserting hole 12 of the tubular body 10, with the arc-shaped top surface 212 of the base body 211 and the arc-shaped lower top surface 2103 of the stepped portion 2102 are substantially conform to the shape of the outer peripheral surface 11 of the tubular body 10. The locating lump 13 of the tubular body 10 is held in the locating gap 2104 of the connector 20, the fixing board 14 is buckled between the buckling portions 216 and the projections 218 and abuts against the connecting arms 215, and the fixing eaves 2101 are held in the respective holding grooves 15 so that the connector 20 is firmly engaged with the tubular body 10. The first fixing ring 30 is worn around the junction of the tubular body 10 and the connector 20 and encircles the stepped portion 2102 and the locating lump 13, and the second fixing ring 40 is worn around the first fixing ring 30 so as to form a firmer engagement between the tubular body 10 and the connector 20. In the process of the connector 20 being mounted into the inserting hole 12 of the tubular body 10, the guiding surfaces 217 of the connector 20 can guide the fixing board 14 of the tubular body 10 to be easily buckled between the projections 218 and the buckling portions 216 under the downward pressure.

As described above, the locating lump 13 of the tubular body 10 is fastened in the locating gap 2104 of the connector 20, and the fixing board 14 is buckled between the buckling portions 216 and the projections 218 so that can prevent the connector 20 from falling off the tubular body 10 under shaking and further remain a steady signal transmission of the digital tubular 1.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A digital pen, comprising:
a tubular body defining an inserting hole at an outer peripheral surface thereof, two opposite side edges of the inserting hole protruding face-to-face to form a locating lump and a fixing board spaced from each other; and
a connector received in the inserting hole of the tubular body and including
an insulating housing having a base body, the base body having a top surface and a rear surface, a rear edge of the top surface extending downward to form a connecting arm located behind the rear surface of the base body with a space therebetween, a free end of the connecting arm protruding opposite to the rear surface to form a buckling portion, a rear of the top surface of the base body extending rearward to form a projection beyond the rear surface, the fixing board of the tubular body being jammed between the buckling portion and the projection from the buckling portion, a front of the insulating housing defining a locating gap for holding the locating lump of the tubular body therein, and
a plurality of terminals integrated in the insulating housing.

2. The digital pen as claimed in claim 1, wherein the buckling portion has an inverted right triangle section of which an inclined plane is acted as a guiding surface opposite to the rear surface of the base body.

3. The digital pen as claimed in claim 1, wherein a pair of holding grooves is provided on another two opposite side edges of the inserting hole of the tubular body, two opposite side edges of the top surface of the base body of the connector extend oppositely to form a pair of fixing eaves held in the corresponding holding grooves.

4. The digital pen as claimed in claim 1, wherein two opposite side edges of the inserting hole where the locating lump and the fixing board are formed are substantially perpendicular to the extending direction of the tubular body.

5. The digital pen as claimed in claim 4, wherein the top surface of the base body defines a plurality of terminal passageways spaced with each other and extending along the extending direction of the tubular body.

6. The digital pen as claimed in claim 5, wherein the projection is positioned between adjacent two of the terminal passageways.

7. The digital pen as claimed in claim 6, wherein each adjacent two of the terminal passageways have a projection therebetween.

8. The digital pen as claimed in claim 7, wherein the connecting arm is positioned between adjacent two of the projections.

9. The digital pen as claimed in claim 8, wherein there are at least two connecting arms.

10. The digital pen as claimed in claim 5, wherein a pair of holding grooves is provided on another two opposite side edges of the inserting hole substantially parallel with the extending direction of the tubular body, two opposite side edges of the top surface of the base body of the connector extend oppositely to form a pair of fixing eaves held in the corresponding holding grooves.

11. The digital pen as claimed in claim 5, wherein a front of the base body extends frontward to form a stepped portion with a lower top surface than that of the base body, the locating gap is defined in the lower top surface of the stepped portion.

12. The digital pen as claimed in claim 4, wherein the tubular body is cylindrical.

13. The digital pen as claimed in claim 12, wherein the top surface of the base body and the lower top surface of the stepped portion are arc-shape substantially conform to the shape of the tubular body.

14. The digital pen as claimed in claim 1, further comprising at least one fixing ring worn around the junction of the tubular body and the connector.
